(19) United States
(12) Patent Application Publication
(10) Pub. No.: US 2008/0074593 A1
(43) Pub. Date: Mar. 27, 2008

(54) LIQUID CRYSTAL DISPLAY DEVICE AND MANUFACTURING METHOD THEREOF

(76) Inventors: Shinji Sekiguchi, Kawasaki (JP); Keiji Takanosu, Yokohama (JP); Yasushi Sano, Yokohama (JP); Koji Hara, Yokohama (JP); Hiroyasu Matsuura, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/845,803

(22) Filed: Aug. 28, 2007

(30) Foreign Application Priority Data
Sep. 22, 2006 (JP) 2006-257285

(51) Int. Cl. G02F 1/1335; H01J 9/24

(52) U.S. Cl. 349/114; 445/24

(57) ABSTRACT

A method of manufacturing a transflective liquid crystal display device including a plurality of pixels each having a reflective display part and a transmissive display part, and a color filter substrate including a retardation plate built in an area of a principal surface of each pixel opposed to a liquid crystal layer, which corresponds to the reflective display part, the method including in the following order: (1) a step of forming an underlayer for aligning molecules of the retardation plate; (2) a step of applying a photosetting material of the retardation plate onto the underlayer; (3) a first exposure step of selectively curing a part of the material of the retardation plate, which corresponds to the reflective display part, by light radiation through a mask; and (4) a second exposure step of heating the material of the retardation plate while exposing an entire surface thereof to light to cure the material of the retardation plate. As a result, a process of manufacturing the transflective liquid crystal display device is simplified while preventing the retardation plate from being colored.

The present application claims a priority from the Japanese patent application No. 2006-257285 filed on Sep. 22, 2006, the content of which is hereby incorporated by reference.

### BACKGROUND OF THE INVENTION

The present invention relates to a liquid crystal display device, and, in particular, to a transflective in-plane switching (IPS) liquid crystal display device and a manufacturing method thereof.

Japanese Patent Application Laid-open No. 2005-338256 (corresponding to US 2005/0264731 A1; hereinafter, referred to as Patent Document 1) describes a transflective IPS liquid crystal display apparatus which applies a lateral electric field to a liquid crystal layer. The transflective IPS liquid crystal display device includes a transmissive display part and a reflective display part in one pixel. The reflective display part includes an internal retardation plate whose retardation is equal to a half wavelength. Further, retardation of the liquid crystal layer in the reflective display part is set to a quarter wavelength to enable reflective display in a wide range of environments, including well-lit places as well as dark places, and to enable transmissive display of high image quality at a wide viewing angle. The internal retardation plate is formed of molecules exhibiting a birefringence such as liquid crystal molecules.

A manufacturing procedure for a color filter-side substrate of such a liquid crystal display apparatus is as follows. Specifically, first, after the formation of a black matrix layer and RGB resist layers, a leveling layer for leveling the black matrix layer and the RGB resist layers is formed. Thereafter, after the formation of an alignment film for generating the alignment function of the internal retardation plate, a rubbing process is performed. By applying material of the internal retardation plate in this state, an oriented state is generated to form the internal retardation plate. The thus formed internal retardation plate is exposed to light and developed to remove an unnecessary area (corresponding to the transmissive display part) to build the retardation plate in a predetermined area (corresponding to the reflective display part).

For the development of the retardation plate layer, an organic solvent is required, imposing a great burden on the cost, environment and process. In this regard, there exists the following method. After the application of material of the retardation plate over the entire surface, only an area required to be provided with a phase difference property is irradiated with light through a mask to be cured. Thereafter, the entirety is light-cured while being heated to cause the phase difference property of the area, where the phase difference property is not needed, to disappear, and the area is cured (see C. Doornkamp et al., Phillips Research, “Next generation mobile LCDs with in-cell retarders”, International Display Workshops 2003, p. 685 (2003); hereinafter, referred to as Non-Patent Document 1). With this method, the organic solvent development process can be omitted.

By simply applying the method described in Non-Patent Document 1, however, the material of the retardation plate may be colored to adversely affect display performance in some cases. Moreover, the method described in Non-Patent Document 1 has to be carried out under a nitrogen atmosphere, resulting in a large-scale device. Therefore, the method is not practical to carry out.

### SUMMARY OF THE INVENTION

The present invention has an object of providing a simple manufacturing process which can prevent a retardation plate from being colored (stained) in a transflective IPS liquid crystal display device in which the retardation plate is built-in, in a reflective display part.

In order to solve the above problem, according to the present invention, a retardation plate material is cured by radiation of light having a predetermined wavelength (wavelength enabling the prevention of coloring of the retardation plate). Therefore, a polymerization initiator of the retardation plate material absorbs the light having the predetermined wavelength, to initiate polymerization.

For example, a first aspect of the present invention relates to a method of manufacturing a transflective IPS liquid crystal display device including a retardation plate, including: a step of forming an underlayer for aligning molecules of the retardation plate; a step of applying a photosetting material of the retardation plate onto the underlayer; a first exposure step of selectively curing a part of the material of the retardation plate, which corresponds to a reflective display part, by light radiation through a mask; and a second exposure step of heating the material of the retardation plate while exposing an entire surface thereof to light to cure the material of the retardation plate. A wavelength of the light radiated for curing the material of the retardation plate is preferably equal to or larger than a predetermined wavelength (for example, 300 nm). Further, a polymerization initiator which absorbs light having a wavelength equal to or larger than the predetermined wavelength to initiate polymerization is preferably used as a polymerization initiator for the material of the retardation plate.

Further, a second aspect of the present invention relates to a transflective IPS liquid crystal display device including: a reflective display part; a transmissive display part; and a retardation plate built in the reflective display part. The retardation plate is formed by curing a part of a resin layer formed over the reflective display part and the transmissive display part to keep a phase difference property of the resin layer. Moreover, transmittance of the resin layer is 90% or higher in the visible light range. For example, when light having a wavelength in a wavelength band from 400 nm to 800 nm is incident on a resin layer, 90% or more of the light is transmitted through the resin layer.

### BRIEF DESCRIPTION OF THE DRAWINGS

In the accompanying drawings:

FIG. 1 is a top view of one pixel in a liquid crystal display device according to the present invention;

FIG. 2 is a sectional view cut along a direction A-A in FIG. 1;

FIG. 3 is a flowchart illustrating a part of a manufacturing process;

FIG. 4 is a diagram illustrating a part of the manufacturing process; and

FIG. 5 is a graph illustrating the relation between a wavelength of a light source, an absorption wavelength of a polymerization initiator, and a wavelength that colors the retardation plate.

### DESCRIPTION OF THE PREFERRED EMBODIMENT

Hereinafter, a liquid crystal display device, to which an embodiment of the present invention is applied, will be described.

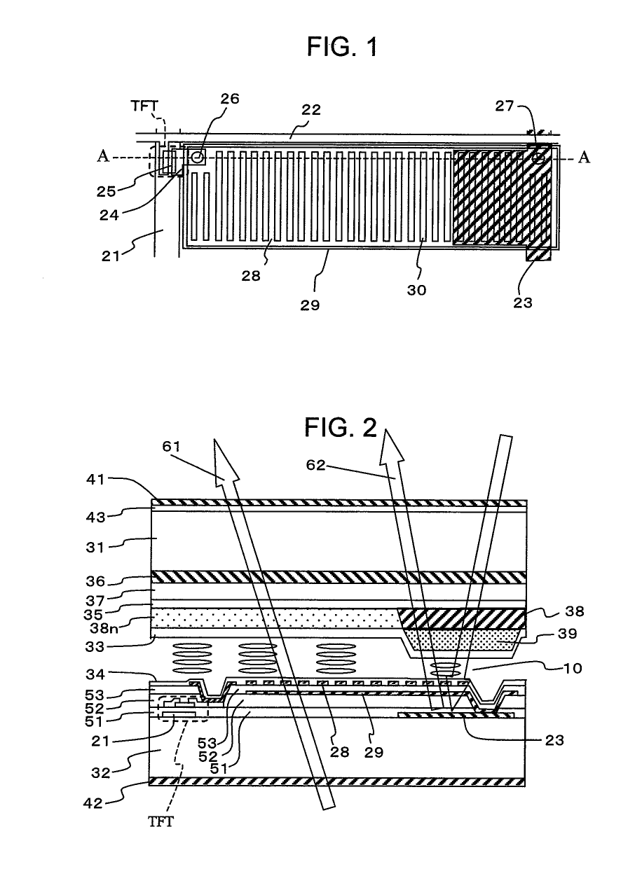

FIG. 1 is a top view of one pixel constituting the liquid crystal display device according to this embodiment. FIG. 2 is a sectional view cut along a direction A-A in FIG. 1.

The liquid crystal display device principally includes a first substrate 31, a second substrate 32, and a liquid crystal layer 10 sandwiched between the first substrate 31 and the second substrate 32.

The first substrate 31 includes, on the liquid crystal layer 10 side in its reflective display part, a color filter 36, a leveling layer 37, a third alignment film 35, a built-in retardation plate 38, a step formation resist layer 39, and a first alignment film 33. The first substrate 31 also includes, on the liquid crystal layer 10 side in its transmissive display part, the color filter 36, the leveling layer 37, the third alignment film 35, a residual layer 38n, and the first alignment film 33.

The first substrate 31 is made of borosilicate glass containing little ionic impurity and has a thickness of 0.5 mm. The color filter 36 is composed of black matrix layers and red (R), green (G), and blue (B) colored resist layers which are repeatedly arranged in a striped manner. Each of the stripes is parallel to a signal wiring 22.

Concavity and convexity of the color filter 36 due to the colored resist layers are leveled by the leveling layer 37 made of a resin. It is preferable that the leveling layer 37 be made of a transparent material. The leveling layer 37 has a thickness normally in the range of 0.5 to 3 μm with the objective of sufficiently leveling the colored resist layers.

The third alignment film 35 serves as an underlayer of the built-in retardation plate 38. The third alignment film 35 is a polyimide-based organic film, and is subjected to an alignment process by a rubbing method to align liquid crystal molecules of the adjacent built-in retardation plate 38 in the alignment process direction.

The built-in retardation plate 38 is obtained by curing a liquid crystal material having a birefringence. The liquid crystal molecules of the built-in retardation plate 38 are aligned by anchoring energy of the third alignment film 35 in contact therewith.

The residual layer 38n is a part of the material applied on the entire surface to form the built-in retardation plate 38, and is a portion whose phase becomes isotropic by heating, and is cured.

The built-in retardation plate 38 and the residual layer 38n are provided with sufficient transparency not to affect display performance by a manufacturing process described below.

The step formation resist layer 39 is provided to form a retardation difference of a quarter wavelength between the reflective display part and the transmissive display part.

The first alignment film 33 is a polyimide-based organic film and is subjected to an alignment process by a rubbing method to align the liquid crystal molecules of the adjacent liquid crystal layer 10 in the alignment process direction.

The second substrate 32 includes a thin film transistor (TFT) on the side closer to the liquid crystal layer 10. The thin film transistor is connected to a scanning wiring 21, the signal wiring 22, and a pixel electrode 28. The thin film transistor has an inversely-staggered structure and has a channel part formed of an amorphous silicon layer 25. Besides, the second substrate 32 includes a common wiring 23 and a common electrode 29. The scanning wiring 21 and the signal wiring 22 intersect with each other. The thin film transistor is positioned approximately at the intersection of the scanning wiring 21 and the signal wiring 22.

The common wiring 23 extends parallel to the scanning wiring 21, and is connected to the common electrode 29 through a second through hole 27.

The pixel electrode 28 and the thin film transistor are connected to each other through a first through hole 26. A second alignment film 34 is provided on the pixel electrode 28. The second alignment film 34 is adjacent to the liquid crystal layer 10 to define the orientation direction of the liquid crystal molecules in the liquid crystal layer 10.

The second substrate 32 is made of borosilicate glass as in the case of the first substrate 31, and has a thickness of 0.5 mm. The second alignment film 34 is made of a polyimide-based organic film having a horizontal alignment property as in the case of the first alignment film 33. The signal wiring 22, the scanning wiring 21, and the common wiring 23 are made of chromium. The pixel electrode 28 is a transparent electrode made of indium tin oxide (ITO). A part of the common electrode 29 is also made of the ITO.

The pixel electrode 28 has slits 30 parallel to the scanning wiring 21. Pitch of the slit 30 is about 4 μm. The pixel electrode 28 and the common electrode 29 are separated from each other by an insulating layer 53 having a thickness of 0.5 μm formed therebetween. Upon application of a voltage, an electric field is formed between the pixel electrode 28 and the common electrode 29. By the effects of the insulating layer 53, however, the electric field is distorted in an arc-like form to pass through the liquid crystal layer 10. As a result, upon application of a voltage, a change is caused in the orientation of the liquid crystal molecules in the liquid crystal layer 10.

The common wiring 23 has a structure that protrudes into the pixel electrode 28 at its intersection with the pixel electrode 28, and reflects light as indicated by reflected light 62 shown in FIG. 2. In FIGS. 1 and 2, an area in which the common wiring 23 overlaps the pixel electrode 28 serves as the reflective display part. An area in which the pixel electrode 28 overlaps the common electrode 29 other than the reflective display part transmits light from a backlight as indicated by transmitted light 61 shown in FIG. 2, and serves as a transmissive display part.

Since an optimal thickness of the liquid crystal layer in the transmissive display part differs from that in the reflective display part, a level step is generated at the boundary between the transmissive display part and the reflective display part. In order to reduce length of the boundary between the transmissive display part and the reflective display part, the transmissive display part and the reflective display part are arranged so that the boundary is parallel to a shorter side of the pixel.

In this manner, if wiring such as the common wiring 23 is also used as a reflector, the effects of reducing the manufacturing process can be obtained. The formation of the common wiring 23 of a metal having a high reflectivity such as aluminum or tantalum provides a brighter reflective display. Even if the common wiring 23 is made of chromium, and a reflector plate made of aluminum or a silver alloy is independently formed, the same effects can be obtained.

The liquid crystal layer 10 is a liquid crystal compound exhibiting positive dielectric constant anisotropy, having a dielectric constant larger in the direction in which it is oriented than in a normal direction. The liquid crystal layer 10 has a birefringence of 0.067 at 25° C., and exhibits a nematic phase in a wide temperature range including room temperature range. During a retention period in which the liquid crystal layer 10 is driven at a frequency of 60 Hz by using the thin film transistor, the liquid crystal layer 10 keeps sufficiently high reflectivity and transmittance to exhibit a high resistance without causing any flicker.

A characteristic process of manufacturing the liquid crystal display device according to this embodiment will now be described.

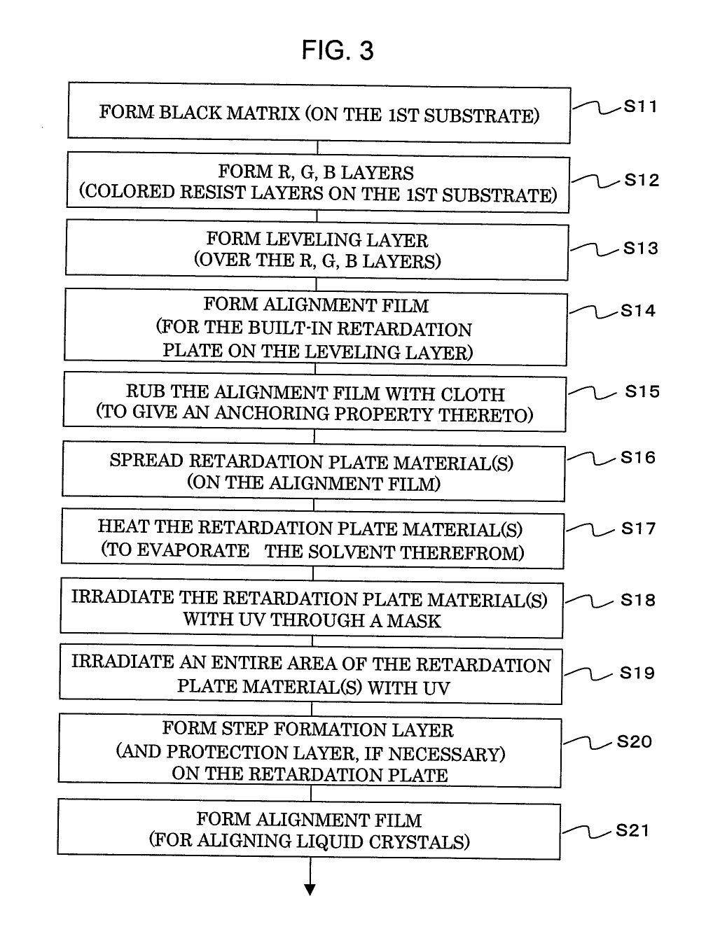

FIG. 3 illustrates a view showing a process from a step of forming the color filter 36 to a step of forming the first alignment film 33 for the first substrate 31.

First, after the formation of the black matrix (S11) and the colored resist layers of three primary colors (S12) on the first substrate 31, the leveling layer 37 is formed (S13).

Next, after the formation of the third alignment film 35 (S14) and the rubbing process (S15), a retardation plate material made of a photosetting resin composition is applied (S16). Subsequently, a solvent is removed by heating (S17). Then, after the retardation plate material is partially cured by the radiation of light through the mask (S18), the entirety is heated to be cured by light (S19).

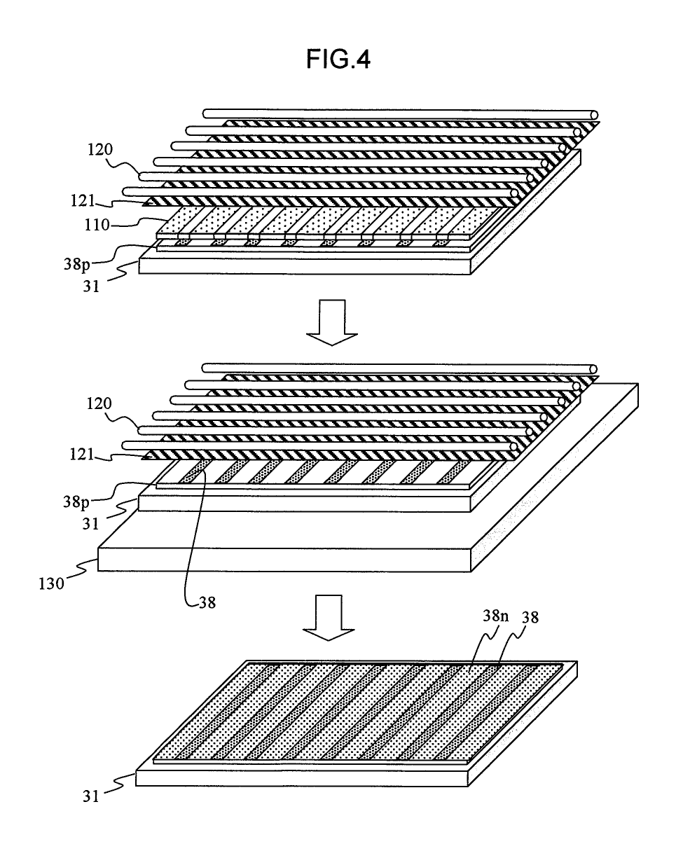

Referring to FIG. 4, a process of forming the built-in retardation plate 38 will be described in detail.

A material 38p of the retardation plate is obtained by dissolving a liquid crystal monomer with an acrylate group and the photo-polymerization initiator in an organic solvent.

First, the material 38p of the retardation plate is applied by spin coating to form a film. Then, the film is baked on a hot plate or the like, at about 100° C. for 2 to 5 minutes to remove the solvent in the film, thereby forming a transparent film. The liquid crystal molecules in the obtained film are aligned by the third alignment film 35.

A mask 110 having an opening to radiate light only on the area corresponding to the reflective display part is placed on the first substrate 31 onto which the material 38p of the retardation plate is applied. Then, the first substrate 31 is exposed to light by lamps 120. The amount of light exposure is about 50 to 200 mJ/cm². As a result, acrylate is polymerized and cured only in the area of the material 38p of the retardation plate, which corresponds to the opening of the mask 110.

UV fluorescent lamps of about 20 W arranged in parallel may be used as the lamps 120. As a result, device cost and operation cost can be held down. A black-light blue (BL-B) florescent lamp, which corresponds to one type of UV fluorescent lamp, may be used as the UV fluorescent lamps. The BL-B fluorescent lamp principally radiates near-ultraviolet light (nominal wavelength band: 300 to 400 nm) and exhibits, for example, a peak wavelength of 360 nm.

Moreover, as described below, it is recommended to provide a UV ray filter 121 between the lamps 120 and the first substrate 31 to shield short-wavelength light.

Next, after the removal of the mask 110, the entire surface of the material 38p is irradiated with light to be perfectly cured while the entirety is being heated by the heater 130. A heating temperature is equal to or higher than a nematic isotropic phase shift temperature (for example, 110° C.). In this manner, an uncured area remaining after the light exposure through the mask is cured after being brought into the isotropic phase. As a result, the residual layer 38n having no phase difference property is formed.

The process of forming the built-in retardation plate 38 and the residual layer 38n formed therewith has been described above.

Next, a material for forming the built-in retardation plate 38, a wavelength of light to be radiated, and the photo-polymerization initiator, which are preferred in this embodiment, will be described. In this embodiment the appropriate selection of these values prevents the built-in retardation plate 38 and the residual layer 38n from being colored.

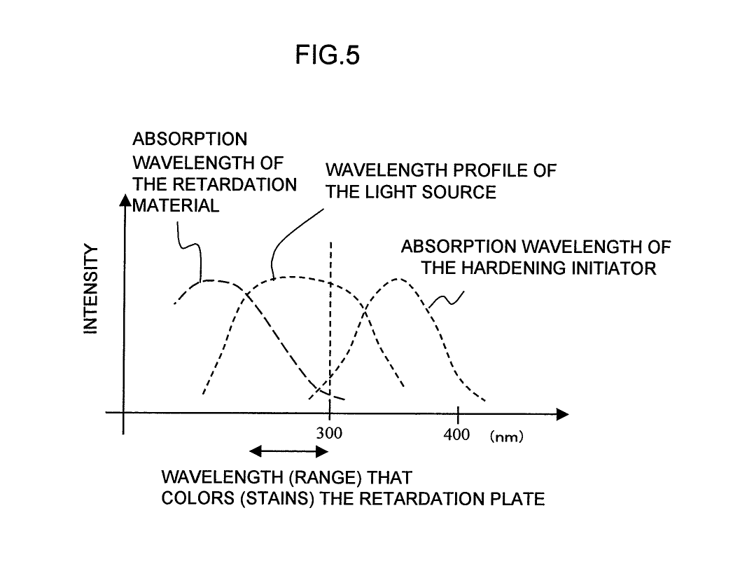

FIG. 5 is a graph for illustrating a wavelength that colors the liquid crystal material which forms the retardation plate. The liquid crystal material for forming the retardation plate is normally colored when the liquid crystal material absorbs light having a wavelength of less than 300 nm. Therefore, it is preferable that light having a wavelength of less than 300 nm not be radiated.

Therefore, the use of a lamp capable of radiating light having a specific wavelength is recommended. For example, a lamp having a higher intensity for light having a wavelength of 300 nm or more while having a lower intensity for light having a wavelength of less than 300 nm is used.

Alternatively, a filter for shielding light having a wavelength of less than 300 nm may be used. For example, a short-wavelength cut UV filter for shielding short-wavelength light is used. Moreover, the use of a filter which cuts out all the absorption wavelengths of the liquid crystal material forming the retardation plate is preferred. For example, a Teijin® Tetoron® Film G2 manufactured by Teijin Dupont Films Japan Limited can be used.

As a result of the selection of the lamp or the filter as described above, light having a wavelength of 300 nm or more is radiated. Therefore, the material 38p of the retardation plate is required to be cured by the radiation of light having a wavelength of 300 nm or more. Accordingly, it is preferred to select the photo-polymerization initiator which absorbs light having a wavelength of 300 to 400 nm. Preferably, the photo-polymerization initiator has an absorption coefficient of 1000 ml/gcm or more at 365 nm and 100 ml/gcm or more at 405 nm.

As material for forming the retardation plate, a liquid crystal monomer with an acrylate group as follows can be used.

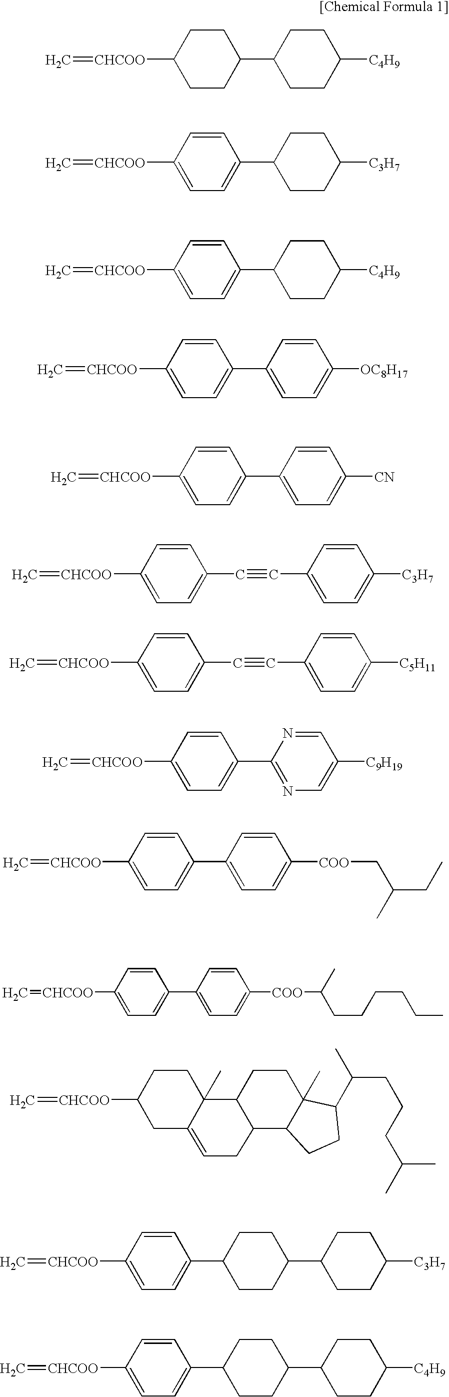

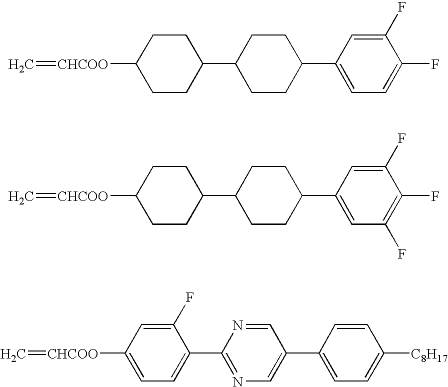

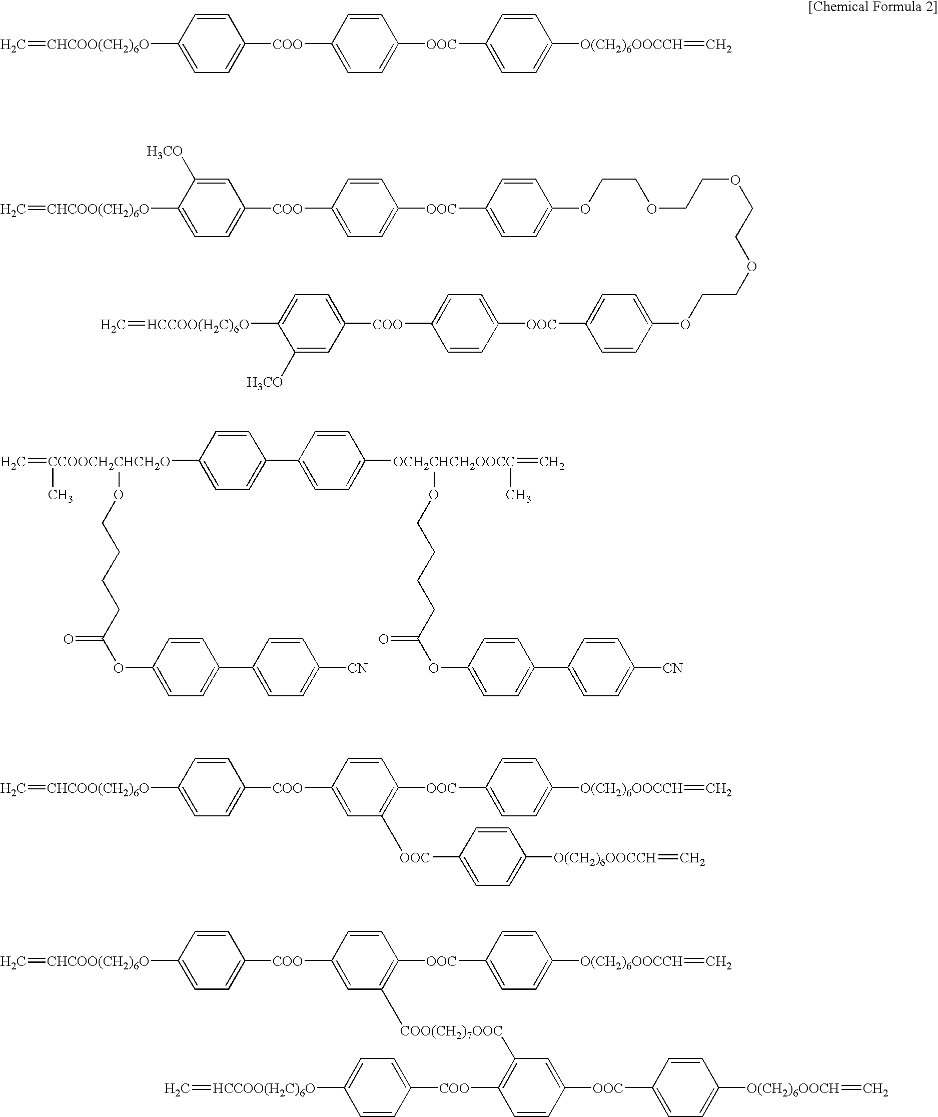

It is preferred that the photo-polymerization initiator be non-volatile in view of heating and light exposure. For example, IRUGACURE® 907, IRUGACURE 369, IRUGACURE 819, IRUGACURE 127, DAROCUR® TPO, IRUGACURE OXE01 or the like manufactured by Ciba Specialty Chemicals can be selected. In particular, because IRUGACURE 819 can prevent coloring and has a low volatility, a small amount of light is sufficient for exposure.

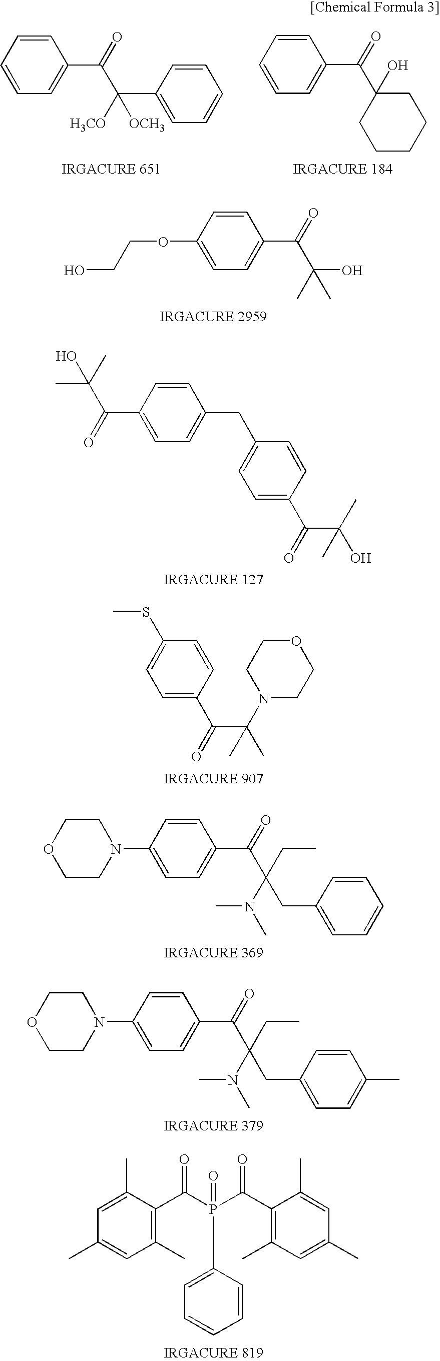

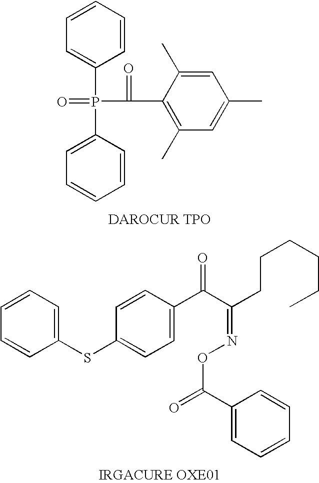

As described above, by appropriately selecting the material of the retardation plate, the wavelength of light to be radiated, and the photo-polymerization initiator, the transmittances of the built-in retardation plate 38 and the residual layer 38n can be made to be 90% or more with respect to visible light (for example, light having a wavelength in the range of 400 to 800 nm). As a result, it is possible to inhibit coloring of the built-in retardation plate 38 and the residual layer 38n.

After the formation of the built-in retardation plate 38, it is preferable to form a protection film (insulating film, not shown in the figures) on the entire principal surface of the first substrate 31 (top faces of the built-in retardation plate 38 and the residual layer 38n formed on the principal surface). The protection film is formed of the same material as that of the above-mentioned leveling layer or a transparent material which does not contain any photoinitiator. After the formation of the step formation resist layer 39 on the upper surface of the residual layer 38n (or the protection film formed thereon) (S20 shown in FIG. 3), the alignment film 33 for aligning the liquid crystal molecules of the liquid crystal layer 10 is formed (S21 shown in FIG. 3). Alternatively, the leveling layer for leveling the underlayer may be formed before the formation of the alignment film 33, and the alignment film 33 is formed on the leveling layer.

The process from the step of forming the color filter 36 to the step of forming the alignment film 33 on the first substrate 31 has been described above.

The subsequent manufacturing process is as follows.

The first alignment film 33 of the first substrate 31 and the second alignment film 34 of the second substrate 32 are subjected to a rubbing process at 15 degrees with respect to the signal wiring 22. Thereafter, the first substrate 31 and the second substrate 32 are assembled to be opposed to each other. The liquid crystal material is sealed between the first substrate 31 and the second substrate 32 to form the liquid crystal layer 10. Further, a first polarizing plate 41 and a second polarizing plate 42 are placed on the outer surface of the first substrate 31 and that of the second substrate 32, respectively. Transmission axes of the first polarizing plate 41 and the second polarizing plate 42 are arranged to be respectively orthogonal to and parallel to the liquid crystal molecule orientation direction.

As an adhesive layer of the first polarizing plate 41, a light-diffusing adhesive layer 43 containing a large number of transparent microspheres having a refractive index different from that of an adhesive material is used. The adhesive layer 43 has the effects of enlarging an optical path of incoming light by taking advantage of the effects of refraction generated by a difference in refractive index between the adhesive material and the microspheres at the boundary therebetween. As a result, the iridescent coloring caused by the interference of reflected light in the pixel electrode 28 and the common electrode 29 can be reduced.

The functions of the liquid crystal display device configured as above will now be described.

As illustrated in FIG. 1, on the principal surface of the second substrate 32 made of a material transparent to visible light such as a glass, the common electrode 29 and the pixel electrode 28 are deposited in this order for each pixel.

Each of the common electrode 29 and the pixel electrode 28 is made of an electrically conductive material which transmits visible light therethrough (so-called transparent conductive film), such as an indium-tin-oxide (ITO) or an indium-zinc-oxide (IZO).

In each pixel, the common electrode 29 is formed in a single sheet-like form. On the other hand, the pixel electrode 28 is formed in a comb-teeth shape on the common electrode 29.

The pixel electrode 28 and the common electrode 29 are electrically separated from each other by the insulating layer 53 for isolating the pixel electrode 28 and the common electrode 29 from each other. An electric flux line generated by a difference in electric potential between the pixel electrode 28 and the common electrode 29 extends from each of the “comb teeth” of the pixel electrode 28 through a gap between the “comb teeth” to reach the common electrode 29.

The electric flux line extends from the “comb teeth” of the pixel electrode 28 toward the gap between the “comb teeth” to be approximately parallel to the principal surface of the second substrate 32. The electric flux line approximately parallel to the principal surface of the second substrate 32 passes through the second alignment film 34 formed on the second substrate 32 to penetrate into the liquid crystal layer 10 sealed between the TFT substrate 32 and the color filter substrate 31 to move the liquid crystal molecules in the liquid crystal layer 10.

The polarizing plates (films) 42 and 41 are provided on the outer surface (principal surface opposite to the liquid crystal layer) of the TFT substrate 32 and that of the color filter substrate 31, respectively.

With no application of an electric field, the optical axes of the liquid crystal molecules in the liquid crystal layer 10 are set in a direction offset from (for example, orthogonal to) those of the polarizing plates 41 and 42. The first alignment film 33 and the second alignment film 34 set the liquid crystal molecules in the above direction. The optical axis herein denotes a direction in which the liquid crystal molecules or the polarizing plates 41 and 42 exhibit, for example, a high refractive index, with respect to light transmitting therethrough.

On the other hand, as the above-mentioned electric field, formed approximately parallel to the principal surface of the second substrate 32 from the “comb teeth” of the pixel electrode 28 toward the common electrode 29, gets stronger, the direction of the optical axis of each of the liquid crystal molecules gradually gets closer to those of the optical axes of the polarizing plates 41 and 42. Specifically, as the electric field formed in the second substrate 32 (in-plane) gets stronger, the amount of light transmitting through the liquid crystal layer 10 becomes larger. This is because the pixel configuration shown in the figure is referred to as an in-plane switching type, abbreviated as IPS.

The electric potential of the pixel electrode 28 varies according to an output (image information) from the thin-film transistor, while the electric potential of the common electrode 29 is determined according to a so-called reference voltage applied from the common wiring 23. Specifically, even when the potentials of the pixel electrodes differ from each other in the group of pixels, each including the common electrode 29 connected to the single common wiring 23, a common potential of each of the pixels is approximately the same.

It is recommended that the common wiring 23 be made of a metal such as aluminum or tantalum to reflect incident light more easily, as compared with the pixel electrode or the common electrode. The illustrated common wiring 23 extends through the through hole 27, through which the common electrode 29 is in contact with the common wiring 23, into the pixel. Therefore, the extending part of the common wiring 23 is provided below the pixel electrode 28 and the common electrode 29 to reflect light, which has passed from the color filter 31 through the liquid crystal layer 10, the pixel electrode 28, and the common electrode 29 to be incident on the extending part (its upper surface), toward the color filter substrate 31. The structure including such an area formed for each pixel is a characteristic of the transflective liquid crystal display device.

One embodiment of the present invention has been described above.

According to the above-mentioned embodiment, in the process of forming the retardation plate, the development step using the organic solvent for removing an unnecessary part can be omitted. Therefore, the embodiment leads to a reduction in process cost as well as in environmental burden.

Moreover, because the built-in retardation plate can be prevented from being colored, display performance can be improved.

Furthermore, the manufacturing method according to the above embodiment does not need any large-scale facilities.

While several embodiments in accordance with the present invention have been shown and described, it is to be understood that the invention is not limited thereto, and various changes and modifications are possible, as known to those skilled in the art; there is no limitation to the details shown and described herein, and the invention covers all such changes and modifications as encompassed by the scope of the appended claims.

What is claimed is:

1. A method of manufacturing a transflective IPS (In-Plane Switching) liquid crystal display device including a retardation plate, comprising:
a step of forming an underlayer for aligning molecules of the retardation plate;
a step of applying a photosetting material of the retardation plate onto the underlayer;
a first exposure step of selectively curing a part of the material of the retardation plate, which corresponds to a reflective display part, by light radiation through a mask; and
a second exposure step of heating the material of the retardation plate while exposing its entire surface to light to cure the material of the retardation plate; wherein:
wavelength of the light radiated for curing the material of the retardation plate is at least equal to a predetermined wavelength; and
a polymerization initiator which absorbs light having a wavelength of at least the predetermined wavelength to initiate polymerization is used as the polymerization initiator for the material of the retardation plate.

2. A method of manufacturing the transflective IPS liquid crystal display device according to claim 1, wherein the material of the retardation plate is heated to a temperature of at least a nematic isotropic phase shift temperature in the second exposure step.

3. A method of manufacturing the transflective IPS liquid crystal display device according to claim 1, wherein the wavelength of the light radiated for curing the material of the retardation plate is at least 300 nm, and the polymerization initiator absorbs light having a wavelength of at least 300 nm to initiate polymerization.

4. A method of manufacturing the transflective IPS liquid crystal display device according to claim 1, wherein the light is radiated using a filter for shielding short-wavelength light.

5. A transflective IPS liquid crystal display device comprising:
a reflective display part;
a transmissive display part; and
a retardation plate built in the reflective display part, wherein:
the retardation plate is formed by curing a part of a resin layer formed over the reflective display part and the transmissive display part to keep a phase difference property of the resin layer; and
a transmittance of the resin layer is at least 90% in a visible light range.
